(19) United States
(12) Patent Application Publication
(10) Pub. No.: US 2026/0112087 A1
(43) Pub. Date: Apr. 23, 2026

(54) ELECTRONIC DEVICE, METHOD, AND NON-TRANSITORY COMPUTER-READABLE STORAGE MEDIUM FOR CHANGING POSTURE OF OBJECT IN IMAGE

(71) Applicant: Samsung Electronics Co., Ltd., Suwon-si (KR)

(72) Inventors: Yoonjin IM, Suwon-si (KR); Junghyun PARK, Suwon-si (KR); Hyunhee PARK, Suwon-si (KR); Sejun SONG, Suwon-si (KR); Jaekyu SHIM, Suwon-si (KR); Arang LEE, Suwon-si (KR); Daejung HAN, Suwon-si (KR); Suejin HAN, Suwon-si (KR)

(21) Appl. No.: 19/272,248

(22) Filed: Jul. 17, 2025

Related U.S. Application Data
(63) Continuation of application No. PCT/KR2025/010113, filed on Jul. 10, 2025.

(30) Foreign Application Priority Data
Oct. 22, 2024 (KR) 10-2024-0144798
Nov. 13, 2024 (KR) 10-2024-0161482

(51) Int. Cl. G06T 11/60

(52) U.S. Cl. CPC G06T 11/60

(57) ABSTRACT

An electronic device includes at least one processor including a processing circuit, display, a display, and memory storing one or more programs configured to be executed individually or collectively by the at least one processor and including one or more storage mediums, and the one or more programs include instructions cause the electronic device to display, via the display, a first image including an object that has a first posture, based on a user input to change the first posture of the object to a second posture of the object, identify an angle by which the object is to be rotated, based on the angle and a reference angle, identify a number in which data associated with the object is to be iteratively provided to a trained model, based on iteratively rotating the object by the reference angle, obtain the object that has the second posture.

### CROSS-REFERENCE TO RELATED APPLICATION(S)

This application is a continuation application, claiming priority under 35 U.S.C. § 365(c), of an International application No. PCT/KR2025/010113, filed on Jul. 10, 2025, which is based on and claims the benefit of a Korean patent application number 10-2024-0144798, filed on Oct. 22, 2024, in the Korean Intellectual Property Office, and of a Korean patent application number 10-2024-0161482, filed on Nov. 13, 2024, in the Korean Intellectual Property Office, the disclosure of each of which is incorporated by reference herein in its entirety.

### TECHNICAL FIELD

The disclosure relates to an electronic device, a method, and a non-transitory computer-readable storage medium for changing a posture of an object in an image.

### BACKGROUND ART

Artificial intelligence (AI) is a technology for simulating a neural activity of a person (or an organism), such as perception and/or inference, and may be implemented in hardware, software, or a combination thereof designed to perform a calculation for simulating the neural activity.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide an electronic device, a method, and a non-transitory computer-readable storage medium for changing posture of an object in an image.

Additional aspects will be set forth in part in the description which follows and, in part, will be apparent from the description, or may be learned by practice of the presented embodiments.

In accordance with an aspect of the disclosure, an electronic device is provided. The electronic device may comprise at least one processor comprising processing circuitry, a display, and memory storing one or more programs configured to be individually or collectively executed by the at least one processor and comprising one or more storage mediums. The one or more programs may comprise instructions to cause the electronic device to display, via the display, a first image including an object that has a first posture. The one or more programs may comprise instructions to cause the electronic device to receive a user input to change the first posture of the object to a second posture of the object. The one or more programs may comprise instructions to cause the electronic device to, based on the user input, identify an angle by which the object is to be rotated to change a posture of the object from the first posture to the second posture. The one or more programs may comprise instructions to cause the electronic device to, based on the angle and a reference angle, identify a number in which data associated with the object is to be iteratively provided to a trained model. The one or more programs may comprise instructions to cause the electronic device to iteratively rotate the object by the reference angle based on iteratively providing the data to the trained model according to the identified number. The one or more programs may comprise instructions to cause the electronic device to, based on iteratively rotating the object by the reference angle, obtain the object that has the second posture. The one or more programs may comprise instructions to cause the electronic device to obtain a second image including the object that has the second posture.

In accordance with another aspect of the disclosure, a method performed by an electronic device including a display is provided. The method may comprise displaying, via the display, a first image including an object that has a first posture. The method may comprise receiving a user input to change the first posture of the object to a second posture of the object. The method may comprise, based on the user input, identifying an angle by which the object is to be rotated to change a posture of the object from the first posture to the second posture. The method may comprise, based on the angle and a reference angle, identifying a number in which data associated with the object is to be iteratively provided to a trained model. The method may comprise iteratively rotating the object by the reference angle based on iteratively providing the data to the trained model according to the identified number. The method may comprise, based on iteratively rotating the object by the reference angle, obtaining the object that has the second posture. The method may comprise obtaining a second image including the object that has the second posture.

In accordance with another aspect of the disclosure, A non-transitory computer readable storage medium is provided. The non-transitory computer readable storage medium may store one or more programs. The one or more programs may comprise instructions to, when executed by an electronic device including a display, cause the electronic device to display, via the display, a first image including an object that has a first posture. The one or more programs may comprise instructions to, when executed by the electronic device, cause the electronic device to receive a user input to change the first posture of the object to a second posture of the object. The one or more programs may comprise instructions to, when executed by the electronic device, cause the electronic device to, based on the user input, identify an angle by which the object is to be rotated to change a posture of the object from the first posture to the second posture. The one or more programs may comprise instructions to, when executed by the electronic device, cause the electronic device to, based on the angle and a reference angle, identify a number in which data associated with the object is to be iteratively provided to a trained model. The one or more programs may comprise instructions to, when executed by the electronic device, cause the electronic device to iteratively rotate the object by the reference angle based on iteratively providing the data to the trained model according to the identified number. The one or more programs may comprise instructions to, when executed by the electronic device, cause the electronic device to, based on iteratively rotating the object by the reference angle, obtain the object that has the second posture. The one or more programs may comprise instructions to, when executed by the electronic device, cause the electronic device to, obtain a second image including the object that has the second posture.

Other aspects, advantages, and salient features of the disclosure will become apparent to those skilled in the art from the following detailed description, which, taken in conjunction with the annexed drawings, discloses various embodiments of the disclosure.

### DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of changing a posture of an object in an image using a plurality of images according to an embodiment of the disclosure;

FIG. 2 is a simplified block diagram of an electronic device according to an embodiment of the disclosure;

FIG. 3 is a flowchart illustrating operations of an electronic device for identifying the number that data associated with an object is iteratively provided to a trained model according to an embodiment of the disclosure;

FIG. 4 illustrates an example of a user input to change a posture of an object according to an embodiment of the disclosure;

FIG. 5 illustrates an example of an angle by which an object is to be rotated and a reference angle according to an embodiment of the disclosure;

FIG. 6 is a flowchart illustrating operations of an electronic device for obtaining an image including an object that has a changed posture according to an embodiment of the disclosure;

FIG. 7 illustrates an example of rotating an object by a reference angle according to an embodiment of the disclosure;

FIG. 8A illustrates an example of obtaining an object that has a changed posture, based on iteratively rotating the object by a reference angle according to an embodiment of the disclosure;

FIG. 8B illustrates an example of at least one trained model according to an embodiment of the disclosure;

FIG. 9 illustrates an example of an image including an object that has a changed posture according to an embodiment of the disclosure;

FIG. 10 is a block diagram of an electronic device in a network environment according to various embodiments; and

FIG. 11 is a schematic diagram of an AI system according to an embodiment of the disclosure.

The same reference numerals are used to represent the same elements throughout the drawings.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, description of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface”includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

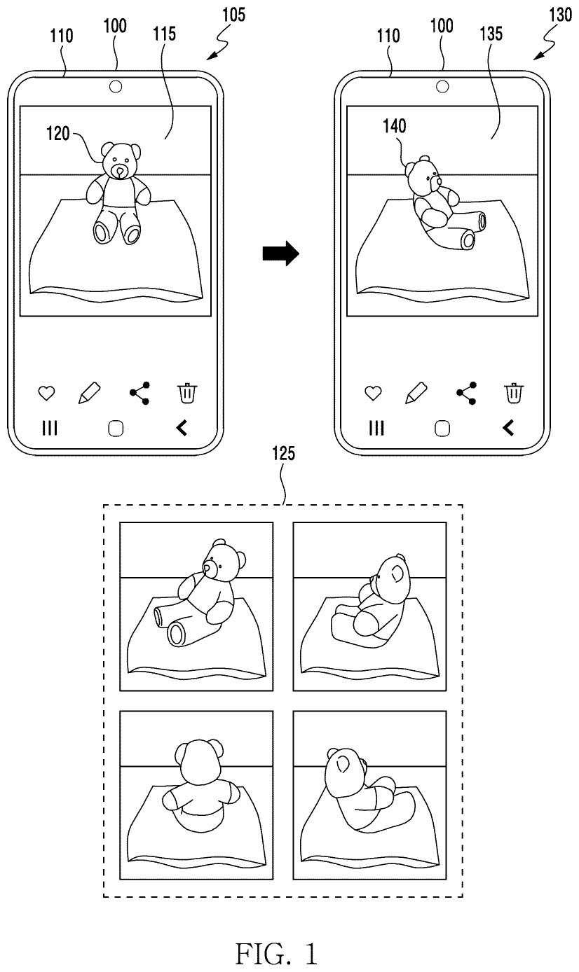

FIG. 1 illustrates an example of changing a posture of an object in an image using a plurality of images according to an embodiment of the disclosure.

Referring to FIG. 1, an electronic device 100 may be described as a device usable to change the posture of the object in the image. For example, the electronic device 100 may be one of various types of mobile devices including circuits (or circuitry) to provide an operation of changing the posture of the object in the image, such as smartphones having various form factors (e.g., a bar-type smartphone, a foldable type smartphone, a multi-foldable type smartphone, or a rollable type smartphone), a tablet, a wearable device, a cellular phone, a personal computer (PC) (e.g., a laptop and/or a desktop), and/or other similar computing devices.

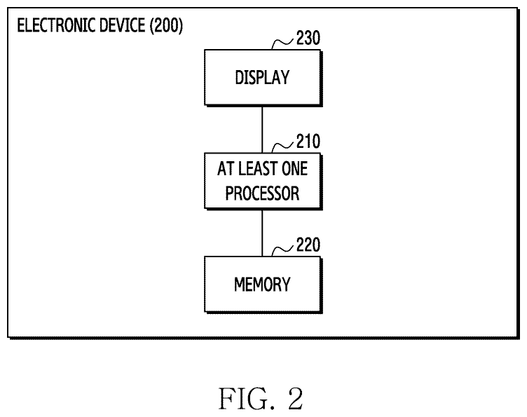

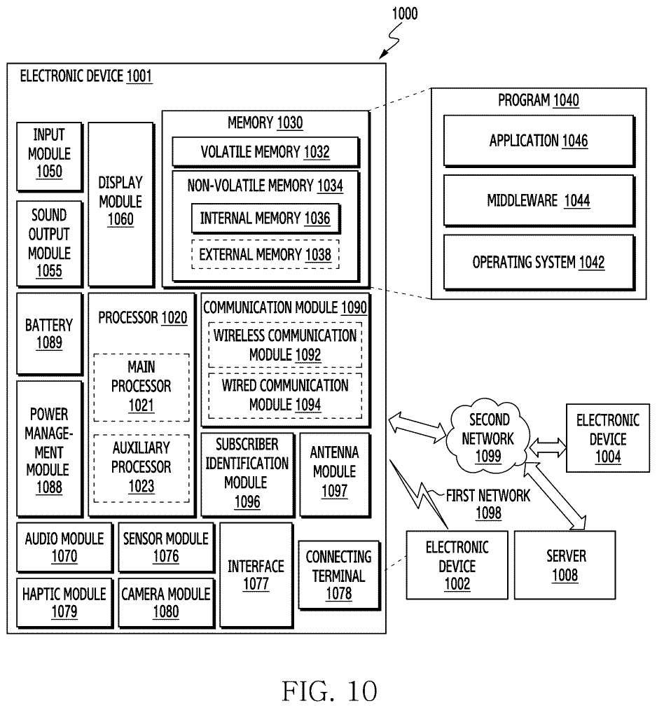

The electronic device 100 may include a display 110 (e.g., a display 230 of FIG. 2 and a display module 1060 of FIG. 10). In a state 105, the electronic device 100 may display, via the display 110, a first image 115 including an object 120. For example, the first image 115 may include the object 120 that has a first posture. For example, the electronic device 100 may receive an input to change a posture of the object 120 from the first posture to a second posture. For example, the electronic device 100 may rotate the object 120 based on the input to change the posture of the object 120 from the first posture to the second posture.

A state 130 may be described as a state in which a second image 135 including an object 140 that has the second posture is displayed via the display 110. The electronic device 100 may use a first trained model to rotate the object 120. For example, the first trained model may be learned to obtain (or generate) an object that has the second posture, using a plurality of images including objects that have postures different from each other. For example, obtaining (or generating) the object 140 that has the second posture rotated from the object 120 that has the first posture using the first trained model may require a plurality of images 125 including objects that have postures different from each other. For example, the electronic device 100 may rotate the object about only one axis using the first trained model. For example, the first trained model may be required to re-learn a parameter of data to learn an object of a new posture. For example, as the object is rotated using the first trained model, a background image excluding the object in the image may be changed. Obtaining the object 140 having the second posture using the first trained model may cause inconvenience to a user by requiring the plurality of images including objects that have postures different from each other (or requiring to learn newly with respect to the object 140 that has the second posture or changing the background image).

The electronic device 100 may use a second trained model to rotate the object 120. For example, the second trained model may be learned to generate an object that has a predetermined (or preset) posture. For example, the second trained model may be required to learn new data to generate an object that has a different posture from the predetermined posture. For example, in a case that the second trained model is not learned to generate the object that has the second posture, changing the first posture of the object 120 to the second posture of the object 140 using the second trained model may have an error. For example, the user may feel uncomfortable, as the second trained model is required to train using a more complex (or a larger) model than the second trained model or is required to perform training additionally in order to generate an object that has the second posture.

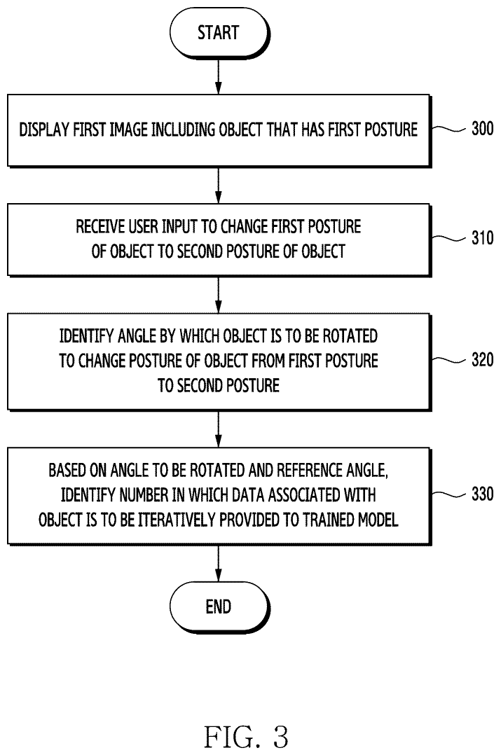

In order to solve this inconvenience of the user, changing the first posture of the object 120 to the second posture of the object 140 may be required, using at least one trained model (e.g., a low-rank adaptation (LoRA) model) different from the first trained model and the second trained model. The electronic device 100 may obtain the second image 135 including the object 140 that has the second posture using the first image 115 without providing additional images to at least one trained model. The electronic device 100 may reduce a size of at least one model by removing an insignificant parameter of the at least one trained model based on parameter pruning. The electronic device 100 may provide learned data from a relatively large trained model to a relatively small trained model by performing knowledge distillation. The electronic device 100 may generate at least one trained model that is relatively small by finding an optimal architecture in an automated method based on a neural architecture search (NAS). The electronic device 100 may reduce memory usage used by performing quantization of a parameter of the at least one trained model into a relatively small data type. The electronic device 100 may reduce the size of the at least one trained model by removing an unnecessary connection of training based on pruning while training the at least one trained model. The at least one trained model may learn objects that have a plurality of postures using an additional parameter other than a fixed parameter. The electronic device 100 may perform operations to be exemplified in a description of FIGS. 3 to 7, 8A, 8B, and 9 to obtain the second image 135. The electronic device 100 may include components for performing the operations. The components may be exemplified in a description of FIG. 2.

FIG. 2 is a simplified block diagram of an electronic device according to an embodiment of the disclosure.

Referring to FIG. 2, the electronic device 200 may be one of various types of mobile devices such as smartphones with various form factors (e.g., a bar-type smartphone, a foldable type smartphone, a multi-foldable type smartphone, or a rollable type smartphone), a tablet, a wearable device, a cellular phone, a personal computer (PC) (e.g., a laptop and/or a desktop), and/or other similar computing devices. For example, the electronic device 200 may include the electronic device 100 of FIG. 1 or may correspond to the electronic device 100 of FIG. 1. For example, the electronic device 200 may include at least a portion of an electronic device 1001 of FIG. 10 or may correspond to at least a portion of the electronic device 1001 of FIG. 10. For example, the electronic device 200 may include at least one processor 210, memory 220, and a display 230.

The at least one processor 210 may include processing circuitry. For example, the at least one processor 210 may include a central processing unit (CPU) (e.g., including processing circuitry). For example, the at least one processor 210 may include a graphic processing unit (GPU) (e.g., including processing circuitry) and/or a neural processing unit (NPU) (e.g., including processing circuitry). For example, the at least one processor 210 may be described as an application processor. For example, the at least one processor 210 may be configured to control the memory 220 and the display 230. The at least one processor 210 may be configured to execute instructions stored in the memory 220 individually or collectively to cause the electronic device 200 to perform at least a portion of the operations exemplified in the description of FIG. 1. The at least one processor 210 may be configured to execute instructions stored in the memory 220 to cause the electronic device 200 to perform at least a portion of operations exemplified in a description of FIGS. 3 to 7, 8A, 8B, and 9.

For example, a term “processor” used in this document, including a scope of claims, may include various processing circuitry including at least one processor, and one or more of the at least one processor may be configured to perform the various functions described below individually and/or collectively in a distributed manner. As used below, in a case that “processor”, “at least one processor”, and “one or more processors” are described as being configured to perform the various functions, these terms, for example, are not limited thereto, and cover situations in which one processor performs a portion of cited functions, and other processor(s) perform another portion of the cited functions, and also situations in which one processor may perform all of the cited functions. Additionally, the at least one processor may include, for example, a combination of processors that perform various functions listed/initiated, in the distributed manner. The at least one processor may execute program instructions to achieve or perform the various functions.

The memory 220 may include one or more storage mediums. For example, the memory 220 may store various data used by at least one component (e.g., the at least one processor 210 and/or the display 230) of the electronic device 200. For example, data may include input data or output data for software and a related command. The memory 220 may include volatile memory or non-volatile memory.

The display 230 may include a touch sensor set to detect a touch, or a pressure sensor set to measure an intensity of a force generated by the touch. For example, the display 230 may be configured to display visual information (e.g., an image). For example, the display 230 may be configured to receive a user input. For example, the display 230 supporting a touch function may be referred to as a touch screen.

The electronic device 200 exemplified in the description of FIG. 2 may execute at least a portion of the operations exemplified in the description of FIGS. 3 to 7, 8A, 8B, and 9. For example, the operations exemplified in the description of FIGS. 3 to 7, 8A, 8B, and 9 may be caused by (or within) the electronic device 200 under control of the at least one processor 210.

FIG. 3 is a flowchart illustrating operations of an electronic device for identifying the number that data associated with an object is iteratively provided to a trained model according to an embodiment of the disclosure.

Referring to FIG. 3, in an operation 300, at least one processor 210 may display, via a display 230, a first image including an object that has a first posture. For example, the first image may include an image stored in the electronic device 200 and/or an image in a web page. For example, the first image may include an image obtained via a camera and/or a drawing image. For example, a posture of an object may be determined according to a direction in which the object faces. For example, the direction in which the object faces may be determined according to a direction in which the object is photographed (or obtained) via the camera.

In an operation 310, the at least one processor 210 may receive a user input to change the first posture of the object to a second posture of an object. For example, the user input to change the posture of the object from the first posture to the second posture may include an input for an angle by which the object is to be rotated to change from the first posture to the second posture. For example, the angle by which the object is to be rotated to change from the first posture to the second posture may be described as an angle of an axis extended (or facing a direction) from a direction (e.g., a front direction) in which the object that has the second posture faces about an axis extended (or facing a direction) from a direction (e.g., a front direction) in which the object that has the first posture faces. For example, the input to the angle by which the object is to be rotated to change from the first posture to the second posture may be represented as a number indicating an angle to be rotated. For example, the angle to be rotated may be configured with an angle (e.g., an azimuth angle) about a first axis of the object that has the first posture and an angle (e.g., an elevation angle) about a second axis of the object that has the first posture.

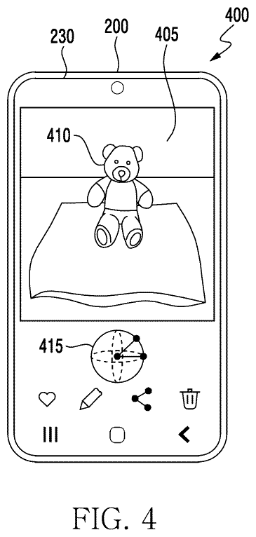

According to an embodiment, the user input to change the posture of the object from the first posture to the second posture may be received (or identified) via a user interface (UI) displayed via the display 230. The user input via the UI is exemplified in a description of FIG. 4.

FIG. 4 illustrates an example of a user input to change a posture of an object according to an embodiment of the disclosure.

Referring to FIG. 4, a state 400 may be described as a state in which a first image 405 including an object 410 that has a first posture is displayed. In the state 400, at least one processor 210, via a display 230, may further display a UI 415 for changing a posture of the object 410 together with the first image 405. For example, the first image 405 and the UI 415 may be displayed in a screen to edit an image.

As an example without limitation, the UI 415 may have a shape of a three dimensional (3D) sphere. The UI 415 may include an indicator indicating a posture of an object to be changed. For example, the at least one processor 210 may receive, via the indicator, a user input to change the first posture of the object 410 to a second posture of the object 410. For example, the user input to change the first posture of the object 410 to the second posture of the object 410 may include a sequence of one or more inputs. The sequence of the one or more inputs may include a touch input that has a contact point on the indicator, an input that drags an object in a direction to rotate, and an input that releases the touch. For example, the indicator may be moved (or rotated) according to a dragging direction. For example, the at least one processor 210 may identify the second posture of the object to be changed from the first posture of the object, based on receiving the drag input and releasing the touch.

According to another embodiment, the first image 405 may include a plurality of objects including the object 410. For example, the at least one processor 210 may identify the plurality of objects in the first image 405. For example, the at least one processor 210 may receive a user input to select an object to change a posture of an object among the plurality of objects while displaying the first image 405. For example, the user input to select the object to change the posture may include a tab input and/or a long press input that have a contact point on the object 410 to change the posture. For example, the user input to select the object to change the posture may include the long press input to the object 410 to change the posture and an input for dragging the object 410 to change the posture onto a predetermined (or preset) area. For example, the user input to select the object to change the posture may include an input for drawing a line surrounding the object 410. For example, based on the user input to select the object to change the posture, the at least one processor 210 may determine an object to change a posture among the plurality of objects included in the image 405. For example, the at least one processor 210 may respectively separate and display the plurality of objects included in the image 405. For example, the at least one processor 210 may receive the user input to determine the object to change the posture among the plurality of objects displayed separately.

For example, based on the user input to select the object to change the posture, the at least one processor 210 may notify the user of a selected object by separately displaying the object to change the posture among the plurality of objects included in the image 405. For example, the at least one processor 210 may receive the user input to change the first posture of the object 410 to the second posture of the object 410 with respect to the object 410 determined as the object to change the posture.

Referring back to FIG. 3, in an operation 320, based on the user input to change the posture of the object from the first posture to the second posture, the at least one processor 210 may detect an object whose posture is to be changed. For example, the at least one processor 210 may separate (or extract) the detected object from the first image. For example, the at least one processor 210 may detect and separate the object in the first image by performing segmentation processing using a trained model (e.g., a segment anything model (SAM)). For example, the trained model may include a machine learning model, a deep learning model, and/or a generative artificial intelligence model.

For example, the at least one processor 210 may identify an angle by which the object is to be rotated to change the posture of the separated (or extracted) object from the first posture to the second posture. For example, the angle by which the object is to be rotated to change from the first posture to the second posture may be described as the angle of the axis extended (or facing the direction) from the direction (e.g., the front direction) in which the object that has the second posture faces about the axis extended (or facing the direction) from the direction (e.g., a front direction) in which the object that has the first posture faces. For example, the angle by which the object is to be rotated to change from the first posture to the second posture may be configured with the angle (e.g., the azimuth angle) about the first axis of the object that has the first posture and the angle (e.g., the elevation angle) about the second axis of the object that has the first posture.

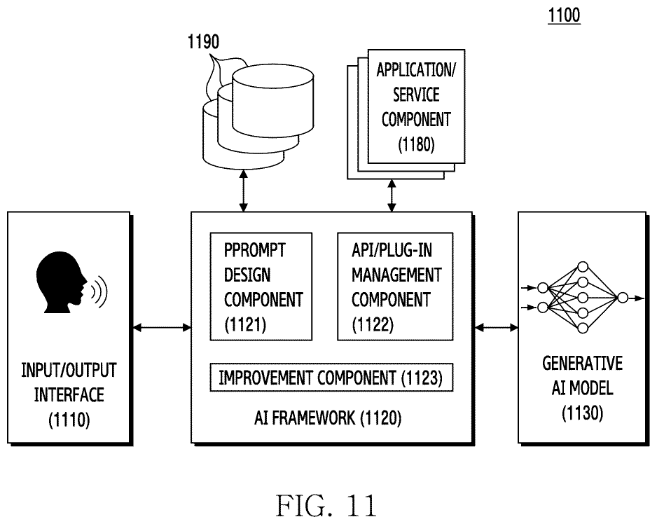

In an operation 330, the at least one processor 210 may, based on the angle to be rotated and a reference angle, identify the number in which data associated with the object is to be iteratively provided to a trained model. For example, the at least one processor 210 may include at least one trained model to rotate an object. For example, the at least one trained model may include the machine learning model, the deep learning model, and/or the generative artificial intelligence model. For example, the at least one trained model may include a low rank adaptation (LoRA) model. For example, the at least one trained model may include LoRA with Hadamard product representation (LoHA), LoRA with Kronecker product representation (LoKA), and/or adapter modules. For example, the at least one trained model may include a generative AI model 1130 of FIG. 11. For example, the at least one trained model may include an artificial neural network model including a plurality of layers and/or an operation (or a calculation). For example, the at least one trained model may learn at least one image corresponding to each of one or more tags (e.g., description information on the image) via fine tuning (e.g., parameter efficient fine tuning (PEFT)).

As an example without limitation, the at least one trained model may include one of a feedforward neural network (FNN), a deep neural network (DNN), a convolutional neural network (CNN), a region with convolution neural network (R-CNN), a region proposal network (RPN), a recurrent neural network (RNN), a stacking-based deep neural network (S-DNN), a state-space dynamic neural network (S-SDNN), a deconvolution network, a restricted Boltzmann machine (RBM), a deep belief network (DBN), a bidirectional recurrent deep neural network (BRDNN), deep Q-networks, a fully convolutional network, long short-term memory (LSTM) network, and a classification network, or may include a combination of two or more of these. However, it is not limited thereto. For example, the at least one trained model may be learned on input data and may obtain output data by performing a calculation (or an inference) based on receiving the input data. The at least one trained model on the electronic device 200 may include a hardware structure, or may include a software structure additional (or alternative) to the hardware structure.

For example, the at least one trained model may be learned to change a posture of an object by rotating the object. For example, the at least one trained model may perform fine tuning of a parameter matrix. For example, the fine tuning may be described as performing additional learning on an already trained model. For example, the at least one trained model may perform fine tuning of a portion of a matrix (e.g., two matrices) of an entire matrix. For example, the portion of the matrix may be described as a matrix that approximate an amount of change in the parameter matrix. For example, the at least one trained model may update a parameter of at least one trained model by fixing the entire matrix and performing the fine tuning of the portion of the matrix. For example, the at least one trained model may learn a plurality of postures of the object relatively quickly by performing additional learning via the fine tuning of the portion of the matrix, and usage of the at least one trained model may be reduced. For example, as the usage of the at least one trained model is reduced, a capacity of the memory 220 of the electronic device 200 allocated to a trained model may be reduced.

For example, the at least one processor 210 may rotate an object by a reference angle by providing (or inputting) the object to the at least one trained model. For example, the reference angle may be defined as an angle by which the object provided (or inputted) to the at least one trained model may be rotated at once. For example, the at least one processor 210 may rotate the object N times by the reference angle by iteratively providing (or inputting) the object N times to the at least one trained model. For example, N may be a natural number. For example, the at least one processor 210 may, based on the angle by which the object is to be rotated and the reference angle, identify the number (e.g., N times) in which data associated with the object is to be iteratively provided to the at least one trained model. For example, the data associated with the object may include output data as the object is provided (or inputted) to the at least one trained model. For example, the output data may include an object rotated by the reference angle from an object inputted to the at least one trained model. For example, the at least one processor 210 may iteratively provide the data associated with the object to the at least one trained model by iteratively providing again the output data to the at least one trained model.

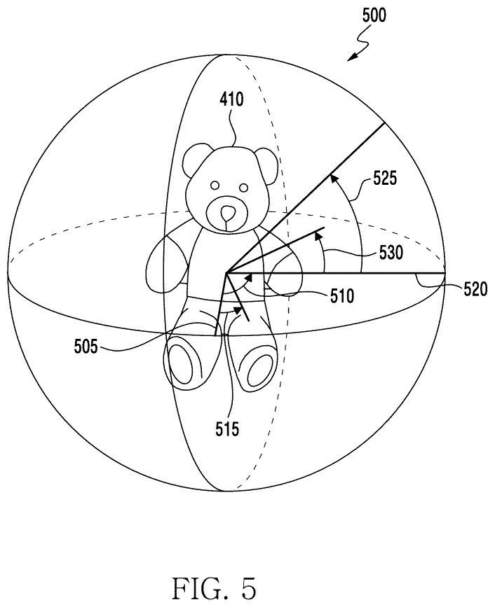

For example, the at least one processor 210 may infer the number to be provided to the at least one trained model by approximating the angle by which the posture of the object is to be rotated from the first posture to the second posture by N times the reference angle. For example, the at least one processor 210 may identify N by identifying N times the reference angle approximating the angle to be rotated. The angle to be rotated and the reference angle are exemplified in a description of FIG. 5.

FIG. 5 illustrates an example of an angle by which an object is to be rotated and a reference angle according to an embodiment of the disclosure.

Referring to FIG. 5, a state 500 may be described as a state in which an object 410 that has a first posture is separated (or extracted) from a first image. In the state 500, at least one processor 210 may identify angles 510 and 525 by which the object 410 is to be rotated to change a posture of the object 410 from the first posture to a second posture. For example, the angles 510 and 525 by which the object 410 is to be rotated may include the angle 510 by which the object 410 is to be rotated about a first axis 505 and the angle 525 by which the object 410 is to be rotated about a second axis 520. For example, the angle 510 by which the object 410 is to be rotated about the first axis 505 may be defined as an azimuth angle, and the angle 525 by which object 410 is to be rotated about the second axis 520 may be defined as an elevation angle.

For example, as the object 410 that has the first posture rotates by the angle 510 about the first axis 505, it may have a third posture. For example, as the object 410 that has the third posture rotates by the angle 525 about the second axis 520, it may have the second posture. For example, the at least one processor 210 may obtain the object 410 that has the second posture based on rotating the object 410 that has the first posture by the angle 510 about the first axis 505 and rotating the object 410 that has the second posture by the angle 525 about the second axis 520.

For example, the at least one processor 210 may, based on an angle by which the object 410 is to be rotated and a reference angle, identify the number (e.g., N times) in which data associated with an object is to be iteratively provided to at least one trained model. For example, the data associated with the object may include output data by being provided (or inputted) to at least one trained model. For example, the output data may include an object rotated by the reference angle from an object inputted to the at least one trained model. For example, the at least one processor 210 may iteratively provide the data associated with the object to the at least one trained model by iteratively providing the output data to the at least one trained model again. For example, the reference angle may be defined as an angle by which the object provided (or inputted) to the at least one trained model may be rotated. For example, the at least one processor 210 may rotate the object N times by the reference angle by iteratively providing (or inputting) the data associated with the object to the at least one trained model N times. For example, the at least one processor 210 may identify the number (e.g., N times) in which the data associated with the object is to be iteratively provided to the at least one trained model by determining N times the reference angle corresponding (or substantially corresponding) to the angle by which the object 410 is to be rotated. As an example without limitation, the at least one processor 210 may identify the number (e.g., N times) in which the data associated with the object is to be iteratively provided to the at least one trained model based on N times the reference angle approximating the reference angle. However, it is not limited thereto.

For example, the at least one trained model may include a first trained model and a second trained model. For example, the first trained model may be described as a model trained to rotate an object about the first axis 505. For example, the second trained model may be described as a model trained to rotate an object about the second axis 520. For example, the first trained model and/or the second trained model may include a LoRA model. For example, the at least one processor 210 may identify the number (e.g., M times) in which data associated with the object 410 is to be iteratively provided to the first trained model based on the angle 510 by which the object 410 is to be rotated about the first axis 505 and a reference angle 515 of the first axis 505. For example, M may be a natural number. For example, the at least one processor 210 may identify the number (e.g., M times) in which the data associated with the object is to be iteratively provided to the first trained model by determining M times the reference angle 515 corresponding to (or substantially corresponding) the angle 510 by which the object 410 is to be rotated about the first axis 505. For example, the at least one processor 210 may identify the number (e.g., K times) in which data associated with the object 410 is to be iteratively provided to the second trained model based on the angle 525 by which the object 410 is to be rotated about the second axis 520 and a reference angle 530 of the second axis 520. For example, K may be a natural number. For example, the at least one processor 210 may identify the number (e.g., K times) in which the data associated with the object is to be iteratively provided to the second trained model by determining K times the reference angle 530 corresponding to (or substantially corresponding) the angle 525 by which the object 410 is to be rotated about the second axis 520.

For example, the at least one processor 210 may determine (or identify) a direction in which the object 410 is to be rotated to change the posture of the object 410 from the first posture to the second posture. For example, the at least one processor 210 may determine (or identify) the direction in which the object 410 is to be rotated to change the posture of the object 410 from the first posture to the second posture, by comparing the number in which the object 410 is to be rotated by the reference angle in a first direction (e.g., clockwise) with the number in which the object 410 is to be rotated by the reference angle in a second direction (e.g., counterclockwise) opposite to the first direction. For example, the at least one processor 210 may determine the direction in which the object 410 is to be rotated as the first direction based on the number in which the object 410 is to be rotated by the reference angle in the first direction less than the number in which the object 410 is to be rotated by the reference angle in the second direction. For example, the direction in which the object 410 is to be rotated may include a direction about to the first axis 505 and a direction about the second axis 520.

For example, For example, the at least one processor 210 may determine (or identify) a direction in which the object 410 is to be rotated about the first axis 505 to change the posture of the object 410 from the first posture to the third posture, by comparing the number in which the object 410 is to be rotated by the reference angle 515 in the first direction about the first axis 505 with the number in which the object 410 is to be rotated by the reference angle 515 about the first axis 505 in the second direction opposite to the first direction. For example, the at least one processor 210 may determine the direction in which the object 410 is to be rotated about the first axis 505 as the first direction, based on the number in which the object 410 is to be rotated by the reference angle 515 in the first direction about the first axis 505 less than the number in which the object 410 is to be rotated by the reference angle 515 in the second direction opposite to the first direction about the first axis 505. For example, the at least one processor 210 may determine (or identify) a direction in which the object 410 is to be rotated about the second axis 520 to change the posture of the object 410 from the third posture to the second posture, by comparing the number in which the object 410 is to be rotated by the reference angle 530 in the first direction about the second axis 520 with the number in which the object 410 is to be rotated by the reference angle 530 in the second direction opposite to the first direction about the second axis 520. For example, the at least one processor 210 may determine the direction in which the object 410 is to be rotated about the first axis 505 as the first direction, based on the number in which the object 410 is to be rotated by the reference angle 530 in the first direction about the second axis 520 less than the number in which the object 410 is to be rotated by the reference angle 530 in the second direction opposite to the first direction about the second axis 520.

For example, the at least one processor 210 may reduce the number in which data associated with the object 410 is provided to the at least one trained model, by determining a direction in which the object 410 is to be rotated relatively less among the first direction and the second direction opposite to the first direction about the first axis 505 (or the second axis 520) as the direction in which the object 410 is to be rotated. For example, the at least one processor 210 may reduce an amount of a calculation of the at least one trained model by reducing the number in which the data associated with the object 410 is provided to the at least one trained model, and may reduce power consumed in an electronic device 200 to execute the at least one trained model.

According to an embodiment, the at least one processor 210 may determine whether to flip the object 410 before rotating the object 410. For example, the at least one processor 210 may flip the object 410 about the first axis 505. For example, a posture of the object 410 flipped about the first axis 505 may correspond to a posture of the object 410 rotated 180 degrees about the first axis 505. For example, the at least one processor 210 may determine whether to flip the object 410 about the first axis 505, by comparing the number in which the object 410 is to be rotated by the reference angle 515 about the first axis 505 after being flipped about the first axis 505 with the number in which the object 410 is to be rotated by the reference angle 515 about the first axis 505 without being flipped about the first axis 505. For example, the at least one processor 210 may determine not to flip the object 410 about the first axis 505, based on the number in which the object 410 is to be rotated by the reference angle 515 about the first axis 505 without being flipped about the first axis 505 less than the number in which the object 410 is to be rotated by the reference angle 515 about the first axis 505 after being flipped about the first axis 505. For example, the at least one processor 210 may determine whether to flip the object 410 about the second axis 520, by comparing the number in which the object 410 is to be rotated by the reference angle 530 about the second axis 520 after being flipped about the second axis 520 with the number in which the object 410 is to be rotated by the reference angle 530 about the second axis 520 without being flipped about the second axis 520. For example, the at least one processor 210 may determine not to flip the object 410 about the second axis 520, based on the number in which the object 410 is to be rotated by the reference angle 530 about the second axis 520 without being flipped about the second axis 520 less than the number in which the object 410 is to be rotated by the reference angle 530 about the second axis 520 after being flipped about the second axis 520.

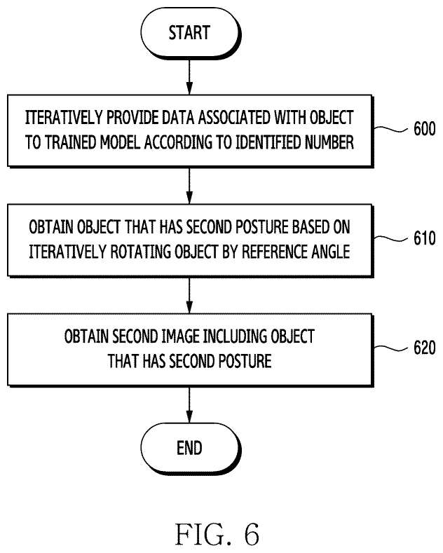

For example, the at least one processor 210 may reduce the number in which the data associated with the object 410 is provided to the at least one trained model, by determining whether to flip the object 410, based on the number in which the object 410 is to be rotated relatively less among rotating the object 410 after flipping it about the first axis 505 (or the second axis 520) and rotating the object 410 without flipping it about the first axis 505 (or the second axis 520). For example, the at least one processor 210 may reduce the amount of the calculation of the at least one trained model by reducing the number in which the data associated with the object 410 is provided to the at least one trained model, and may reduce power consumed in the electronic device 200 to execute the at least one trained model. For example, the at least one processor 210 may iteratively provide the data associated with the object 410 to the at least one trained model according to the identified number (or a direction, or whether to flip the object 410). In order to obtain an object that has a changed posture, iteratively providing the data associated with the object 410 to the at least one trained model is exemplified in a description of FIG. 6.

FIG. 6 is a flowchart illustrating operations of an electronic device for obtaining an image including an object that has a changed posture according to an embodiment of the disclosure.

Referring to FIG. 6, in an operation 600, at least one processor 210 may iteratively provide data associated with the object to at least one trained model according to an identified number. For example, the identified number may be described as the number (e.g., N times) in which the data associated with the operation 330 of FIG. 3 and the object in FIG. 5 is to be iteratively provided to a trained model.

For example, the data associated with the object may include an object that has an intermediate posture between a first posture of the object and a second posture of the object. For example, iteratively providing (or inputting) the data associated with the object to the at least one trained model may include providing (or inputting) an object obtained from the at least one trained model to the at least one trained model again.

For example, the at least one processor 210 may further provide a prompt to the at least one trained model. For example, the prompt may indicate an angle (e.g., φ=30 or θ=10) by which the object is to be rotated, the number (e.g., N=3 or N̅=6) in which the object is to be rotated by a reference angle, a direction (e.g., clockwise (CW) or counterclockwise (CCW)) in which the object is to be rotated, and/or whether to flip the object. For example, the at least one processor 210 may generate the prompt, based on identifying the angle (or the number in which the object is to be rotated by the reference angle, or the direction in which the object is to be rotated, or whether to flip the object) by which the object is to be rotated to change the posture of the object from the first posture to the second posture. For example, the at least one processor 210 may iteratively provide the prompt to the at least one trained model according to the identified number (e.g., N times).

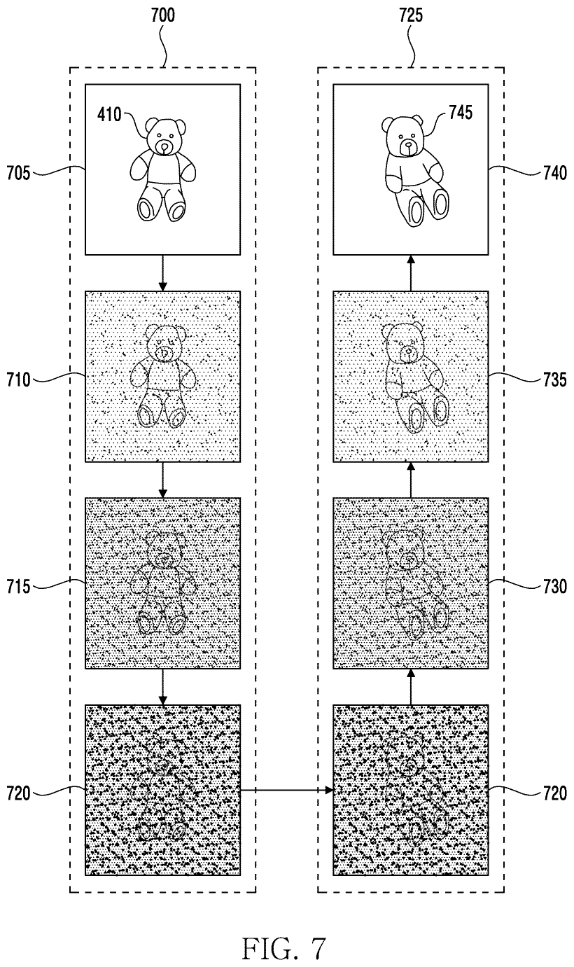

For example, the at least one processor 210 may rotate the object by the reference angle by providing the object to the at least one trained model. For example, using the at least one trained model, rotating the object by the reference angle is exemplified in a description of FIG. 7.

FIG. 7 illustrates an example of rotating an object by a reference angle according to an embodiment of the disclosure.

Referring to FIG. 7, at least one trained model may include a diffusion model. For example, the diffusion model may be described as a generative artificial intelligence model to generate an image by being provided with (or inputting) a text and an image prompt. For example, the diffusion model may include a variational auto encoder (VAE), a variational auto decoder (VAD), a conditioning, and/or a noise predictor. For example, at least one processor 210 may perform forward diffusion 700, using the at least one trained model. For example, the at least one processor 210 may, based on the variational auto encoder (VAE), input original data and generate a latent variable by performing the forward diffusion 700. For example, the latent variable may be defined as a random vector following a standard normal distribution. For example, the at least one processor 210 may generate noise data (e.g., random noise) by coupling a time step with the latent variable generated based on the conditioning by performing the forward diffusion 700. For example, the at least one processor 210 may provide the at least one trained model with a pixel image (e.g., a 512×512 pixel image) including an object 410 that has a first posture to perform the forward diffusion 700. For example, the variational auto encoder of the at least one trained model may convert an image (e.g., a 64×64 image) 705 into a vector indicating an pixel image by reducing (or downsizing) the pixel image including the object 410 that has the first posture. For example, the vector indicating the image 705 may be configured with numbers describing the image 705.

For example, the noise predictor of the at least one trained model may add (or inject or generate) noise to the vector indicating the image 705 by performing the forward diffusion 700. For example, a vector function may be used to perform the forward diffusion 700. For example, the at least one trained model may generate a vector indicating a first noise image 710, a vector indicating a second noise image 715, and/or a vector indicating a final noise image 720 by adding noise for each step of the forward diffusion 700. For example, the vectors may be used to model a change in data according to a degree of the noise.

For example, the noise predictor of the at least one trained model may remove the noise of the final noise image 720 by performing reverse diffusion 725 on the vector indicating the final noise image 720. For example, a convolutional neural network (CNN) model (e.g., U-net) may be used to perform the reverse diffusion 725. For example, the at least one processor 210 may predict the noise data based on the noise predictor and a latent variable based on an input of a time step by performing the reverse diffusion 725. For example, the at least one processor 210 may restore original data by inputting the predicted latent variable and the time step, based on a variational auto decoder (VAD) of the reverse diffusion 725. For example, the at least one trained model may predict noise to be removed in the final noise image 720. For example, the at least one trained model may remove noise for each step of the reverse diffusion 725, by removing the predicted noise (or performing denoising). For example, a vector function may be used to perform the reverse diffusion 725. For example, the at least one trained model may generate a vector indicating a third noise image 730, a vector indicating a fourth noise image 735, and/or a vector indicating a final image 740 by removing the noise for each step of the reverse diffusion 725. For example, the final image 740 may include an object 745 of a fourth posture rotated by a reference angle from the object 410 of the first posture. For example, the conditioning of the at least one trained model may provide a prompt to the noise predictor to control the noise predictor for each step of the reverse diffusion. For example, the at least one trained model may rotate the object 745 according to a direction (or the number) indicated by the prompt. For example, by iteratively performing the forward diffusion 700 and the reverse diffusion 725, the at least one trained model (e.g., the diffusion model) may learn distribution of the original data.

For example, the variational auto decoder of the at least one trained model may rotate the object 410 that has the first posture by the reference angle by enlarging (or restoring) the vector indicating the final image 740 including the object 745 of the fourth posture to the pixel image (e.g., the 512×512 pixel image). For example, the at least one processor 210 may iteratively rotate the object by the reference angle by providing the object 745 that has the fourth posture to the at least one trained model again.

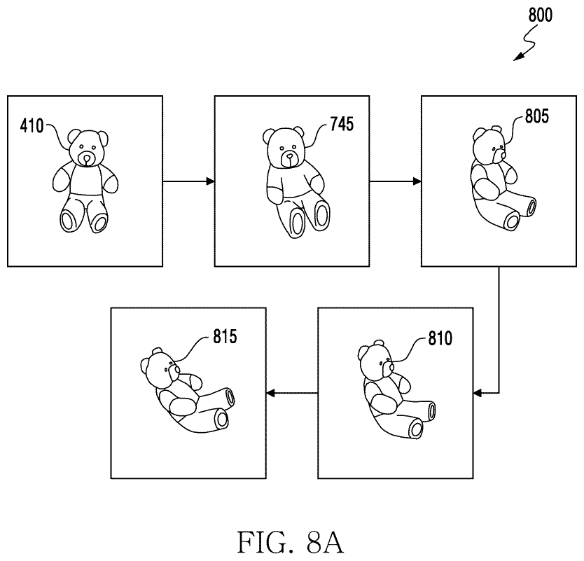

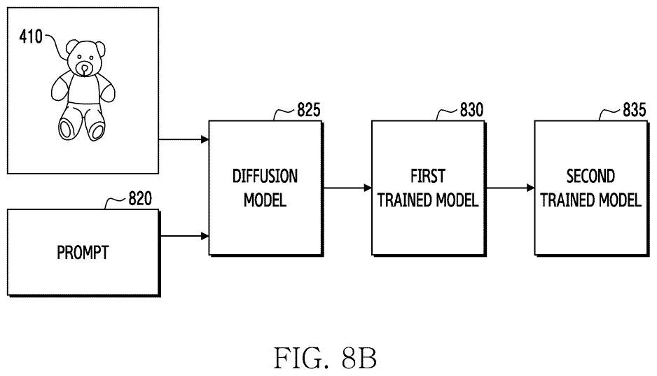

Referring back to FIG. 6, in an operation 610, the at least one processor 210 may obtain the object that has the second posture based on iteratively rotating the object by the reference angle. Iteratively rotating the object by the reference angle to obtain the object that has the second posture is exemplified in a description of FIG. 8A.

FIG. 8A illustrates an example of obtaining an object that has a changed posture, based on iteratively rotating the object by a reference angle according to an embodiment of the disclosure.

FIG. 8B illustrates an example of at least one trained model according to an embodiment of the disclosure.

Referring to FIG. 8A, a state 800 may be described as a state in which an object is iteratively rotated. For example, in the state 800, at least one processor 210 may rotate an object 410 that has a first posture by the reference angle by providing the object 410 that has the first posture to at least one trained model (e.g., a first trained model). For example, as the object 410 that has the first posture rotates by the reference angle, an object 745 may have a fourth posture. For example, the object 745 that has the fourth posture may be described as an object in which the object 410 that has the first posture is rotated by a first reference angle (e.g., the first reference angle 515 of FIG. 5) about a first axis (e.g., the first axis 505 of FIG. 5).

For example, the at least one processor 210 may rotate the object 745 that has the fourth posture by the first reference angle about the first axis by providing the object 745 that has the fourth posture to the first trained model again. For example, the at least one processor 210 may obtain an object 805 that has a third posture by rotating the object 745 that has the fourth posture by the first reference angle about the first axis. For example, the at least one processor 210 may rotate an object about a second axis (e.g., the second axis 520 of FIG. 5) after rotation of the object about the first axis is completed.

For example, the at least one processor 210 may rotate the object 805 that has the third posture by a second reference angle about the second axis by providing the object 805 that has the third posture to a second trained model again. For example, the at least one processor 210 may obtain an object 810 that has a fifth posture by rotating the object 805 that has the third posture by the second reference angle about the second axis. For example, the at least one processor 210 may rotate the object 810 that has the fifth posture by the second reference angle about the second axis by providing the object 810 that has the fifth posture to the second trained model again. For example, the at least one processor 210 may obtain an object 815 that has a second posture by rotating the object 810 that has the fifth posture by the second reference angle about the second axis. For example, the at least one processor 210 may obtain the object 815 that has the second posture in response to a user input to change a posture of the object 410 from the first posture to the second posture.

For example, data associated with the object iteratively provided to the at least one trained model (e.g., the first trained model and/or the second trained model) may include the object 410 that has the first posture, the object 745 that has the fourth posture, the object 805 that has the third posture, and/or the object 810 that has the fifth posture. For example, the at least one processor 210 may further provide a prompt indicating an angle (or a direction in which an object is to be rotated, or the number in which the object is to be rotated by the reference angle) by which the object is to be rotated together with the data associated with the object. For example, the at least one processor 210 may obtain the object 745 that has the fourth posture, the object 805 that has the third posture, and/or the object 810 that has the fifth posture and/or the object 815 that has second posture by iteratively providing the prompt.

For example, the at least one processor 210 may obtain the object 815 that has the second posture, using only one image (e.g., a first image including the object 410 that has the first posture). For example, the at least one processor 210 may not require a plurality of images including an object that has a plurality of postures to obtain the object 815 that has the second posture, using at least one model. For example, the at least one processor 210 may obtain the object 815 that has the second posture, using the relatively small number of models (e.g., the first trained model and/or the second trained model). For example, as the relatively small number of models (e.g., the first trained model and/or the second trained model) being used to obtain the object 815 that has the second posture, time and/or data required to train a trained model may be reduced.

For example, the at least one processor 210 may obtain the object 815 that has the second posture rotated about a plurality of axes from the object 410 that has the first posture, using the at least one trained model (e.g., the first trained model and the second trained model) learned to rotate an object about different axes. For example, the at least one processor 210 may iteratively rotate the object by iteratively providing data associated with the object to the at least one trained model. For example, the at least one processor 210 may obtain an object rotated by another angle other than an angle learned by the at least one trained model by iteratively rotating the object.

Referring to FIG. 8B, the at least one trained model may include a diffusion model 825, a first trained model 830, and/or a second trained model 835. For example, the diffusion model 825 may include a variational auto encoder (VAE), a variational auto decoder (VAD), conditioning, and/or a noise predictor. For example, the diffusion model 825 may be referred to as the diffusion model of FIG. 7.

For example, the first trained model 830 and/or the second trained model 835 may be described as a LoRA model. For example, the first trained model 830 may be described as a model trained to rotate an inputted object about the first axis (e.g., the first axis 505 of FIG. 5). For example, the second trained model 835 may be described as a model trained to rotate an inputted object about the second axis (e.g., the second axis 520 of FIG. 5).

For example, the at least one processor 210 may obtain the object 745 that has the fourth posture by providing the object 410 that has the first posture and a prompt 820 to the diffusion model 825 and the first trained model 830. For example, the prompt 820 may indicate an angle by which the object is to be rotated (or the direction in which the object is to be rotated, or the number in which the object is to be rotated by the reference angle). For example, the at least one processor 210 may provide the object 745 that has the fourth posture to the diffusion model 825 and the first trained model 830 again. For example, the at least one processor 210 may obtain the object 805 that has the third posture by providing the object 745 that has the fourth posture and the prompt 820 to the diffusion model 825 and the first trained model 830.

For example, the at least one processor 210 may obtain the object 810 that has the fifth posture by providing the object 805 that has the third posture and the prompt 820 to the diffusion model 825 and the second trained model 835. For example, the at least one processor 210 may provide the object 810 that has the fifth posture to the diffusion model 825 and the second trained model 835 again. For example, the at least one processor 210 may obtain the object 815 that has the second posture by providing the object 810 that has the fifth posture and the prompt 820 to the diffusion model 825 and the second trained model 835.

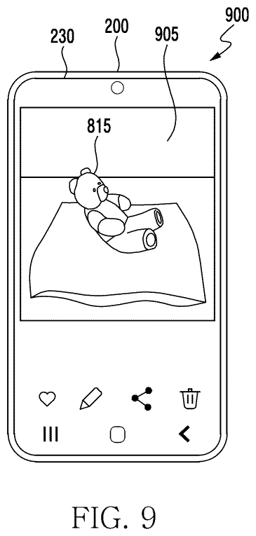

For example, the at least one processor 210 may display a second image including the object 815 that has the second posture changed from the first posture via a display 230. Displaying the second image including the object 815 that has the second posture is exemplified in a description of FIG. 9.

FIG. 9 illustrates an example of an image including an object that has a changed posture according to an embodiment of the disclosure.

Referring to FIG. 9, at least one processor 210 may obtain a second image 905 including an object 815 that has a second posture. For example, a state 900 may be described as a state in which the second image 905 including the object 815 that has the second posture is displayed. In the state 900, the at least one processor 210 may obtain the second image 905 using the object 815 that has the second posture and a first image, based on obtaining the object 815 that has the second posture by iteratively providing data associated with the object to at least one trained model. For example, the at least one processor 210 may obtain the second image 905 by synthesizing the object 815 that has the second posture with the first image or adding the object 815 that has the second posture to the first image from which the object that has the first posture is removed. For example, the at least one processor 210 may change a viewpoint (e.g., an angle of a camera) from which the object was photographed to emphasize the object by changing a posture of an object (e.g., a person) from the first posture to the second posture. For example, the at least one processor 210 may synthesize the rotated object to be positioned in another space by changing a posture of an object (e.g., furniture) from the first posture to the second posture. For example, the at least one processor 210 may obtain an object viewed from a plurality of angles by changing a posture of an object (e.g., person drawing) from the first posture to the second posture and generate media content (e.g., cartoons and/or a videos) using the object whose posture has changed. For example, the at least one processor 210 may obtain the second image 905, by adding the object 815 that has the second posture to the first image from which the object that has the first posture is removed using a trained model (e.g., a stochastic differential equation (SDE) model). For example, the at least one processor 210 may obtain the second image 905 in which the object that has the first posture is rotated in the first image and remaining representations (e.g., a background image) other than the object is maintained (or fixed), by obtaining the second image 905, using the object 815 that has the second posture and the first image. For example, the at least one processor 210 may obtain the second image 905 by performing inpainting on an area not occupied by the object 815 that has the second posture in the first image from which the object that has the first posture is removed. For example, the at least one processor 210 may adjust a degree of noise (or a state of data with added noise) for each step of reverse diffusion by performing the reverse diffusion (e.g., the reverse diffusion 725 of FIG. 7) using a trained model (e.g., the stochastic differential equation (SDE) model) and model a process of restoring an image.

For example, the at least one processor 210 may display the second image 905 including the object 815 that has the second posture via a display 230 in response to a user input to change the posture of the object from the first posture to the second posture. For example, the at least one processor 210 may provide a user with the object 815 that has the second posture requested from the user by displaying the second image 905.

FIG. 10 is a block diagram illustrating an electronic device in a network environment according to various embodiments.

Referring to FIG. 10, an electronic device 1001 in a network environment 1000 may communicate with an electronic device 1002 via a first network 1098 (e.g., a short-range wireless communication network), or at least one of an electronic device 1004 or a server 1008 via a second network 1099 (e.g., a long-range wireless communication network). According to an embodiment, the electronic device 1001 may communicate with the electronic device 1004 via the server 1008. According to an embodiment, the electronic device 1001 may include a processor 1020, memory 1030, an input module 1050, a sound output module 1055, a display module 1060, an audio module 1070, a sensor module 1076, an interface 1077, a connecting terminal 1078, a haptic module 1079, a camera module 1080, a power management module 1088, a battery 1089, a communication module 1090, a subscriber identification module (SIM) 1096, or an antenna module 1097. In some embodiments, at least one of the components (e.g., the connecting terminal 1078) may be omitted from the electronic device 1001, or one or more other components may be added in the electronic device 1001. In some embodiments, some of the components (e.g., the sensor module 1076, the camera module 1080, or the antenna module 1097) may be implemented as a single component (e.g., the display module 1060).

The processor 1020 may execute, for example, software (e.g., a program 1040) to control at least one other component (e.g., a hardware or software component) of the electronic device 1001 coupled with the processor 1020, and may perform various data processing or computation. According to an embodiment, as at least part of the data processing or computation, the processor 1020 may store a command or data received from another component (e.g., the sensor module 1076 or the communication module 1090) in volatile memory 1032, process the command or the data stored in the volatile memory 1032, and store resulting data in non-volatile memory 1034. According to an embodiment, the processor 1020 may include a main processor 1021 (e.g., a central processing unit (CPU) or an application processor (AP)), or an auxiliary processor 1023 (e.g., a graphics processing unit (GPU), a neural processing unit (NPU), an image signal processor (ISP), a sensor hub processor, or a communication processor (CP)) that is operable independently from, or in conjunction with, the main processor 1021. For example, when the electronic device 1001 includes the main processor 1021 and the auxiliary processor 1023, the auxiliary processor 1023 may be adapted to consume less power than the main processor 1021, or to be specific to a specified function. The auxiliary processor 1023 may be implemented as separate from, or as part of the main processor 1021.

The auxiliary processor 1023 may control at least some of functions or states related to at least one component (e.g., the display module 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). According to an embodiment, the auxiliary processor 1023 (e.g., an image signal processor or a communication processor) may be implemented as part of another component (e.g., the camera module 1080 or the communication module 1090) functionally related to the auxiliary processor 1023. According to an embodiment, the auxiliary processor 1023 (e.g., the neural processing unit) may include a hardware structure specified for artificial intelligence model processing. An artificial intelligence model may be generated by machine learning. Such learning may be performed, e.g., by the electronic device 1001 where the artificial intelligence is performed or via a separate server (e.g., the server 1008). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034.

The program 1040 may be stored in the memory 1030 as software, and may include, for example, an operating system (OS) 1042, middleware 1044, or an application 1046.

The input module 1050 may receive a command or data to be used by another component (e.g., the processor 1020) of the electronic device 1001, from the outside (e.g., a user) of the electronic device 1001. The input module 1050 may include, for example, a microphone, a mouse, a keyboard, a key (e.g., a button), or a digital pen (e.g., a stylus pen).

The sound output module 1055 may output sound signals to the outside of the electronic device 1001. The sound output module 1055 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1060 may visually provide information to the outside (e.g., a user) of the electronic device 1001. The display module 1060 may include, for example, a display, a hologram device, or a projector and control circuitry to control a corresponding one of the display, hologram device, and projector. According to an embodiment, the display module 1060 may include a touch sensor adapted to detect a touch, or a pressure sensor adapted to measure the intensity of force incurred by the touch.

The audio module 1070 may convert a sound into an electrical signal and vice versa. According to an embodiment, the audio module 1070 may obtain the sound via the input module 1050, or output the sound via the sound output module 1055 or a headphone of an external electronic device (e.g., an electronic device 1002) directly (e.g., wiredly) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. According to an embodiment, the sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device (e.g., the electronic device 1002) directly (e.g., wiredly) or wirelessly. According to an embodiment, the interface 1077 may include, for example, a high definition multimedia interface (HDMI), a universal serial bus (USB) interface, a secure digital (SD) card interface, or an audio interface.

A connecting terminal 1078 may include a connector via which the electronic device 1001 may be physically connected with the external electronic device (e.g., the electronic device 1002). According to an embodiment, the connecting terminal 1078 may include, for example, an HDMI connector, a USB connector, an SD card connector, or an audio connector (e.g., a headphone connector).

The haptic module 1079 may convert an electrical signal into a mechanical stimulus (e.g., a vibration or a movement) or electrical stimulus which may be recognized by a user via his tactile sensation or kinesthetic sensation. According to an embodiment, the haptic module 1079 may include, for example, a motor, a piezoelectric element, or an electric stimulator.

The camera module 1080 may capture a still image or moving images. According to an embodiment, the camera module 1080 may include one or more lenses, image sensors, image signal processors, or flashes.

The power management module 1088 may manage power supplied to the electronic device 1001. According to an embodiment, the power management module 1088 may be implemented as at least part of, for example, a power management integrated circuit (PMIC).

The battery 1089 may supply power to at least one component of the electronic device 1001. According to an embodiment, the battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the application processor (AP)) and supports a direct (e.g., wired) communication or a wireless communication. According to an embodiment, the communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as Bluetooth™, wireless-fidelity (Wi-Fi) direct, or infrared data association (IrDA)) or the second network 1099 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The wireless communication module 1092 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1092 may support a high-frequency band (e.g., the millimeter wave (mmWave) band) to achieve, e.g., a high data transmission rate. The wireless communication module 1092 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1092 may support various requirements specified in the electronic device 1001, an external electronic device (e.g., the electronic device 1004), or a network system (e.g., the second network 1099). According to an embodiment, the wireless communication module 1092 may support a peak data rate (e.g., 20 Gbps or more) for implementing eMBB, loss coverage (e.g., 1064 dB or less) for implementing mMTC, or U-plane latency (e.g., 0.5 ms or less for each of downlink (DL) and uplink (UL), or a round trip of 10 ms or less) for implementing URLLC.

The antenna module 1097 may transmit or receive a signal or power to or from the outside (e.g., the external electronic device) of the electronic device 1001. According to an embodiment, the antenna module 1097 may include an antenna including a radiating element composed of a conductive material or a conductive pattern formed in or on a substrate (e.g., a printed circuit board (PCB)). According to an embodiment, the antenna module 1097 may include a plurality of antennas (e.g., array antennas). In such a case, at least one antenna appropriate for a communication scheme used in the communication network, such as the first network 1098 or the second network 1099, may be selected, for example, by the communication module 1090 (e.g., the wireless communication module 1092) from the plurality of antennas. The signal or the power may then be transmitted or received between the communication module 1090 and the external electronic device via the selected at least one antenna. According to an embodiment, another component (e.g., a radio frequency integrated circuit (RFIC)) other than the radiating element may be additionally formed as part of the antenna module 1097.

According to various embodiments, the antenna module 1097 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1001 and the external electronic device 1004 via the server 1008 coupled with the second network 1099. Each of the electronic devices 1002 or 1004 may be a device of a same type as, or a different type, from the electronic device 1001. According to an embodiment, all or some of operations to be executed at the electronic device 1001 may be executed at one or more of the external electronic devices 1002, 1004, or 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, a cloud computing, distributed computing, mobile edge computing (MEC), or client-server computing technology may be used, for example. The electronic device 1001 may provide ultra low-latency services using, e.g., distributed computing or mobile edge computing. In another embodiment, the external electronic device 1004 may include an internet-of-things (IoT) device. The server 1008 may be an intelligent server using machine learning and/or a neural network. According to an embodiment, the external electronic device 1004 or the server 1008 may be included in the second network 1099. The electronic device 1001 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1040) including one or more instructions that are stored in a storage medium (e.g., internal memory 1036 or external memory 1038) that is readable by a machine (e.g., the electronic device 1001). For example, a processor (e.g., the processor 1020) of the machine (e.g., the electronic device 1001) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The technical problems to be achieved in this document are not limited to those described above, and other technical problems not mentioned herein will be clearly understood by those having ordinary knowledge in the art to which the disclosure belongs, from the following description.

A portion of the operations described above may be executed (or performed) via an AI system (or an artificial intelligence system) described with reference to FIG. 11.

FIG. 11 is a schematic diagram of an AI system according to an embodiment of the disclosure.

Referring to FIG. 11, an AI system 1100 may include an input/output interface 1110, an AI framework 1120, a generative AI model 1130 (or a generative artificial intelligence model), and/or a knowledge repository 1190.

The input/output interface 1110 may receive an input. The input may include data obtained or generated by a user input and/or an electronic device (e.g., the electronic device 200 or the electronic device 1001 described above). The data may include an image, a video, and/or sensor data (e.g., a sensor or a sensor hub (e.g., illuminance data around the electronic device obtained from the auxiliary processor 1023, Posture data (or orientation data) of the electronic device, a temperature inside the electronic device (e.g., a temperature of a display 230 or a temperature of at least one processor 210), size information of the display area of the display 230, and/or an image obtained through an image sensor (e.g., included in a camera module 1080) of the electronic device) generated by at least one processor (e.g., at least one processor 210 or a processor 1020) of the electronic device. The user input may include a natural language, touch data obtained via touch circuitry (e.g., used to identify input from a finger and/or stylus) included in a display panel, an image displayed (and/or to be displayed) on the display panel, and/or a video. As an example without limitation, the user input may be received by the input/output interface 1110 together with context information. The situation information may be described as additional information obtained in connection with the user input. The situation information may be associated with a state (e.g., including a state of the electronic device and/or a state (e.g., a user state) around the electronic device) when the user input is received. For example, the context information may include information on one or more software applications executed within the electronic device when the user input is received. For example, the situation information may include information on a position of the electronic device (or a user's position of the electronic device) when the user input is received. The user input may be integrated with the situation information. As the input, the user input integrated with the situation information may be received via the input/output interface 1110.

The input/output interface 1110 may transmit (or provide) an output. The output may include a result (or result information) generated or obtained by the AI system 1100 based at least in part on the input. A format of the output may vary. For example, the output may include a natural language. For example, the output may include content (e.g., including media content and/or multimedia content). For example, the output may include an action associated with a user of the electronic device. For example, the output may have a format according to a user setting of the electronic device.

The input/output interface 1110 may be described as a user query/response interface 1110.

The AI framework 1120 may be used to obtain information (or data) on the input from the input/output interface 1110 and control one or more components associated with the AI system 1100 using the obtained information.

For example, a prompt design component 1121 in the AI framework 1120 may generate or obtain a prompt for the generative AI model 1130 (e.g., including a large language model (LLM) or a large multimodal model (LMM)), using the obtained information. For example, the prompt design component 1121 may be described as an AI component that uses a learning algorithm and/or a neural network to provide a reinforced prompt over time. For example, the prompt design component 1121 may generate or obtain a prompt by accessing a knowledge component (e.g., the knowledge repository 1190) including user preference data, a prompt library, and/or a prompt example using the obtained information. The generated prompt may be provided to the generative AI model 1130 (e.g., including the LLM or the LMM).

For example, an API/plug-in management component 1122 in the AI framework 1120 may be used to support communication for additional information requested (or caused) in connection with the prompt provided (or to be provided) to the generative AI model 1130. For example, the API/plug-in management component 1122 may be used to generate or establish a channel for communication with various data sources (e.g., the knowledge repository 1190). For example, the API/plug-in management component 1122 may support access to at least some of the data sources. For example, the API/plug-in management component 1122 may be used to request another component (e.g., an application/service component 1180) that performs feedback (or response) according to the prompt. As an example without limitation, information obtained (or generated) via the API/plug-in management component 1122 may be provided to the prompt design component 1121 for generation of a prompt. As an example, without limitation, information obtained (or generated) via the API/plug-in management component 1122 may be provided to the generative AI model 1130.

For example, an improvement component 1123 in the AI framework 1120 may at least partially tune (or adjust)(or change) a result (e.g., content) obtained (or outputted) from the generative AI model 1130. For example, the improvement component 1123 may determine or verify whether the content obtained from the generative AI model 1130 is associated with the input. For example, the improvement component 1123 may determine or verify whether the content obtained from the generative AI model 1130 includes biased content. For example, the improvement component 1123 may determine or verify whether the content obtained from the generative AI model 1130 includes harmful content. For example, the improvement component 1123 may support or assist performing additional processing to improve the content obtained from the generative AI model 1130. For example, the improvement component 1123 may support providing a hint to the user to improve the content.

The generative AI model 1130 may be described as an artificial intelligence neural network that generates feedback in response to a prompt. For example, the feedback is associated with the prompt, but may further include additional data and/or information relative to the prompt. For example, the feedback may include new content in relative to the prompt. For example, the generative AI model 1130 may include a model generating an image and/or a model generating a language. For example, the model generating the image may include a generative adversarial network (GAN) and/or a variational auto encoder (VAE). For example, the model that generating the image may include a diffusion-based generative model (e.g., a transformer VAE). For example, the model generating the language may include CHAT-GPT 3 and/or CHAT-GPT 4. For example, the generative AI model 1130 may include an LMM generating the feedback by recognizing text, image, and/or voice.

As an example without limitation, the AI framework 1120 and/or the generative AI model 1130 may be included in an AI module (e.g., including processing circuitry) in the electronic device 200. For example, the AI module may be operably coupled with at least one processor (e.g., the at least one processor 210 or the processor 1020) of the electronic device 200. For example, the AI module may be operably coupled with display driving circuitry of the electronic device. For example, the AI module may be operably coupled with a sensor hub of the electronic device for one or more sensors in the electronic device.

As described above, the electronic device (e.g., the electronic device 200 of FIG. 2) may comprise at least one processor (e.g., the at least one processor 210 of FIG. 2) comprising processing circuitry, a display (e.g., the display 230 of FIG. 2) and memory (e.g., the memory 220 of FIG. 2) storing one or more programs configured to be individually or collectively executed by the at least one processor, and comprising one or more storage mediums. The one or more programs may comprise instructions to cause the electronic device to display, via the display, a first image (e.g., the first image 405 of FIG. 4) including an object (e.g., the object 410 having the first posture of FIG. 4) that has a first posture. The one or more programs may comprise instructions to cause the electronic device to receive a user input to change the first posture of the object to a second posture of the object. The one or more programs may comprise instructions to cause the electronic device to, based on the user input, identify an angle by which the object is to be rotated to change a posture of the object from the first posture to the second posture. The one or more programs may comprise instructions to cause the electronic device to, based on the angle and a reference angle, identify a number in which data associated with the object is to be iteratively provided to a trained model. The one or more programs may comprise instructions to cause the electronic device to iteratively rotate the object by the reference angle based on iteratively providing the data to the trained model according to the identified number. The one or more programs may comprise instructions to cause the electronic device to, based on iteratively rotating the object by the reference angle, obtain the object (e.g., the object 815 having the second posture of FIG. 8A) that has the second posture. The one or more programs may comprise instructions to cause the electronic device to obtain a second image (e.g., the second image 905 of FIG. 9) including the object that has the second posture.

For example, the one or more programs may comprise instructions to cause the electronic device to, based on the user input, identify a direction in which the object is to be rotated to change a posture of the object from the first posture to the second posture. The one or more programs may comprise instructions to cause the electronic device to, based on the angle, the reference angle, and the direction, identify the number in which the data is to be iteratively provided to the trained model. The one or more programs may comprise instructions to cause the electronic device to iteratively rotate the object by the reference angle in the direction based on iteratively providing the data to the trained model according to the identified number. The one or more programs may comprise instructions to cause the electronic device to, based on iteratively rotating the object by the reference angle in the direction, obtain the object that has the second posture.

For example, the one or more programs may comprise instructions to cause the electronic device to, based on the angle, the reference angle, and another direction opposite to the direction, identify another number in which another data associated with the object is to be iteratively provided to the trained model. The one or more programs may comprise instructions to cause the electronic device to, based on the number less than the another number, determine the direction as a direction in which the object to be rotated. The one or more programs may comprise instructions to cause the electronic device to iteratively rotate the object by the reference angle in the direction based on iteratively providing the data to the trained model according to the number.

For example, the one or more programs may comprise instructions to cause the electronic device to, based on identifying the number, generate a prompt indicating the direction and the angle. The one or more programs may comprise instructions to cause the electronic device to iteratively rotate the object by the reference angle in the direction based on further providing the prompt to the trained model.

For example, the angle may be a first angle. The reference angle may be a first reference angle. The data may be first data. The number may be a first number. The one or more programs may comprise instructions to cause the electronic device to, based on the user input, identify a second angle by which the object is to be rotated about a first axis to change a posture of the object from the first posture to a third posture between the first posture and the second posture. The one or more programs may comprise instructions to cause the electronic device to, based on the second angle and a second reference angle, identify a second number in which second data associated with the object is to be iteratively provided to the trained model. The one or more programs may comprise instructions to cause the electronic device to iteratively rotate the object by the second reference angle about the first axis based on iteratively providing the second data to the trained model according to the second number. The one or more programs may comprise instructions to cause the electronic device to, based on iteratively rotating the object by the second reference angle about the first axis, obtain the object that has the third posture. The one or more programs may comprise instructions to cause the electronic device to identify a third angle by which the object is to be rotated about a second axis to change a posture of the object from the third posture to the second posture. The one or more programs may comprise instructions to cause the electronic device to, based on the third angle and a third reference angle, identify a third number in which third data associated with the object is to be iteratively provided to the trained model. The one or more programs may comprise instructions to cause the electronic device to iteratively rotate the object by the third reference angle about the second axis based on iteratively providing the third data to the trained model according to the third number. The one or more programs may comprise instructions to cause the electronic device to, based on iteratively rotating the object by the third reference angle about the second axis, obtain the object that has the second posture.

For example, the trained model may be a first trained model, and may include a second trained model used to rotate the object about the first axis and a third trained model used to rotate the object about the second axis. The one or more programs may comprise instructions to cause the electronic device to iteratively rotate the object by the second reference angle about the first axis based on iteratively providing the second data to the second trained model according to the second number. The one or more programs may comprise instructions to cause the electronic device to, based on iteratively rotating the object by the second reference angle about the first axis, obtain the object that has the third posture. The one or more programs may comprise instructions to cause the electronic device to iteratively rotate the object by third reference angle about the second axis, based on iteratively providing the third data to the third trained model according to the third number. The one or more programs may comprise instructions to cause the electronic device to, based on iteratively rotating the object by the third reference angle about the second axis, obtain the object that has the second posture.

For example, at least one among the first trained model, the second trained model, and the third trained model may include a low-rank adaptation (LoRA) model.

For example, the one or more programs may comprise instructions to cause the electronic device to obtain the second image by synthesizing the object that has the second posture and the first image.

For example, the one or more programs may comprise instructions to cause the electronic device to, based on the angle and the reference angle, determine whether to flip the object before rotating the object. The one or more programs may comprise instructions to cause the electronic device to, based on determining not to flip the object, identify the number in which the data is to be iteratively provided to the trained model according to the angle and the reference angle. The one or more programs may comprise instructions to cause the electronic device to, based on determining to flip the object, obtain the object that has a third posture by flipping the object. The one or more programs may comprise instructions to cause the electronic device to identify another angle by which the object is to be rotated to change a posture of the object from the third posture to the second posture. The one or more programs may comprise instructions to cause the electronic device to, based on the another angle and the reference angle, identify another number in which another data associated with the object is to be iteratively provided to the trained model. The one or more programs may comprise instructions to cause the electronic device to iteratively rotate the object by the reference angle based on iteratively providing the another data to the trained model according to the another number. The one or more programs may comprise instructions to cause the electronic device to, based on iteratively rotating the object by the reference angle, obtain the object that has the second posture. The one or more programs may comprise instructions to cause the electronic device to obtain the second image including the object that has the second posture.

For example, the one or more programs may comprise instructions to cause the electronic device to compare the identified number with the identified another number. The one or more programs may comprise instructions to cause the electronic device to, based on the another number more than the number, determine not to flip the object. The one or more programs may comprise instructions to cause the electronic device to, based on the another number less than the number, determine to flip the object.

For example, the one or more programs may comprise instructions to cause the electronic device to obtain a noise image by providing the data to the trained model. The one or more programs may comprise instructions to cause the electronic device to, based on providing the noise image to the trained model again, rotate the object by the reference angle.

For example, the user input may further indicate selecting the object as an object to be rotated.

For example, the data may include the object that has the first posture and the object rotated by the reference angle N times while changing a posture of the object from the first posture to the second posture. The N may be a natural number.

As described above, the method may be performed in an electronic device comprising a display. The method may comprise displaying, via the display, a first image including an object that has a first posture. The method may comprise receiving a user input to change the first posture of the object to a second posture of the object. The method may comprise, based on the user input, identifying an angle by which the object is to be rotated to change a posture of the object from the first posture to the second posture. The method may comprise, based on the angle and a reference angle, identifying a number in which data associated with the object is to be iteratively provided to a trained model. The method may comprise iteratively rotating the object by the reference angle based on iteratively providing the data to the trained model according to the identified number. The method may comprise, based on iteratively rotating the object by the reference angle, obtaining the object that has the second posture. The method may comprise obtaining a second image including the object that has the second posture.

For example, the method may comprise, based on the user input, identifying a direction in which the object is to be rotated to change a posture of the object from the first posture to the second posture. The method may comprise, based on the angle, the reference angle, and the direction, identifying the number in which the data is to be iteratively provided to the trained model. The method may comprise iteratively rotating the object by the reference angle in the direction, based on iteratively providing the data to the trained model according to the identified number. The method may comprise, based on iteratively rotating the object by the reference angle in the direction, obtaining the object that has the second posture.

For example, the method may comprise, based on the angle, the reference angle, and another direction opposite to the direction, identifying another number in which another data associated with the object is to be iteratively provided to the trained model. The method may comprise, based on the number less than the another number, determining the direction as a direction in which the object to be rotated. The method may comprise iteratively rotating the object by the reference angle in the direction based on iteratively providing the data to the trained model according to the number.

For example, the method may comprise, based on identifying the number, generating a prompt indicating the direction and the angle. The method may comprise iteratively rotating the object by the reference angle in the direction based on further providing the prompt to the trained model.

For example, the angle may be a first angle. The reference angle may be a first reference angle. The data may be first data. The number may be a first number. The method may comprise, based on the user input, identifying a second angle by which the object is to be rotated about a first axis to change a posture of the object from the first posture to a third posture between the first posture and the second posture. The method may comprise, based on the second angle and a second reference angle, identifying a second number in which second data associated with the object is to be iteratively provided to the trained model. The method may comprise iteratively rotating the object by the second reference angle about the first axis based on iteratively providing the second data to the trained model according to the second number. The method may comprise identifying a third angle by which the object is to be rotated about a second axis to change a posture of the object from the third posture to the second posture. The method may comprise, based on iteratively rotating the object by the second reference angle about the first axis, obtaining the object that has the third posture. The method may comprise identifying a third angle by which the object is to be rotated about a second axis to change a posture of the object from the third posture to the second posture. The method may comprise, based on the third angle and a third reference angle, identifying a third number in which third data associated with the object is to be iteratively provided to the trained model. The method may comprise iteratively rotating the object by the third reference angle about the second axis based on iteratively providing the third data to the trained model according to the third number. The method may comprise, based on iteratively rotating the object by the third reference angle about the second axis, obtaining the object that has the second posture.

For example, the trained model may be a first trained model, and include a second trained model used to rotate the object about the first axis and a third trained model used to rotate the object about the second axis. The method may comprise iteratively rotating the object by the second reference angle about the first axis based on iteratively providing the second data to the second trained model according to the second number. The method may comprise, based on iteratively rotating the object by the second reference angle about the first axis, obtaining the object that has the third posture. The method may comprise iteratively rotating the object by the third reference angle about the second axis based on iteratively providing the third data to the third trained model according to the third number. The method may comprise, based on iteratively rotating the object by the third reference angle about the second axis, obtaining the object that has the second posture.

For example, at least one among the first trained model, the second trained model, and the third trained model may include a low-rank adaptation (LoRA) model.

For example, the method may comprise obtaining the second image by synthesizing the object that has the second posture and the first image.

For example, the method may comprise, based on the angle and the reference angle, determining whether to flip the object before rotating the object. The method may comprise, based on determining not to flip the object, identifying the number in which the data is to be iteratively provided to the trained model according to the angle and the reference angle. The method may comprise, based on determining to flip the object, obtaining the object that has a third posture by flipping the object. The method may comprise identifying another angle by which the object is to be rotated to change a posture of the object from the third posture to the second posture. The method may comprise, based on the another angle and the reference angle, identifying another number in which another data associated with the object is to be iteratively provided to the trained model. The method may comprise iteratively rotating the object by the reference angle based on iteratively providing the another data to the trained model according to the another number. The method may comprise, based on iteratively rotating the object by the reference angle, obtaining the object that has the second posture. The method may comprise obtaining the second image including the object that has the second posture.

For example, the method may comprise comparing the identified number with the identified another number. The method may comprise, based on the another number more than the number, determining not to flip the object. The method may comprise, based on the another number less than the number, determining to flip the object.

For example, the method may comprise obtaining a noise image by providing the data to the trained model. The method may comprise, based on providing the noise image to the trained model again, rotating the object by the reference angle.

For example, the user input may further indicate selecting the object as an object to be rotated.

For example, the data may include the object that has the first posture and the object rotated by the reference angle N times while changing a posture of the object from the first posture to the second posture. The N may be a natural number.

As described above, the non-transitory computer readable storage medium may store one or more programs. The one or more programs may comprise instructions to, when executed by an electronic device including a display, cause the electronic device to display, via the display, a first image including an object that has a first posture. The one or more programs may comprise instructions to, when executed by the electronic device, cause the electronic device to receive a user input to change the first posture of the object to a second posture of the object. The one or more programs may comprise instructions to, when executed by the electronic device, cause the electronic device to, based on the user input, identify an angle by which the object is to be rotated to change a posture of the object from the first posture to the second posture. The one or more programs may comprise instructions to, when executed by the electronic device, cause the electronic device to, based on the angle and a reference angle, identify a number in which data associated with the object is to be iteratively provided to a trained model. The one or more programs may comprise instructions to, when executed by the electronic device, cause the electronic device to iteratively rotate the object by the reference angle based on iteratively providing the data to the trained model according to the identified number. The one or more programs may comprise instructions to, when executed by the electronic device, cause the electronic device to, based on iteratively rotating the object by the reference angle, obtain the object that has the second posture. The one or more programs may comprise instructions to, when executed by the electronic device, cause the electronic device to, obtain a second image including the object that has the second posture.

For example, the one or more programs may comprise instructions to, when executed by the electronic device, cause the electronic device to, based on the user input, identify a direction in which the object is to be rotated to change a posture of the object from the first posture to the second posture. The one or more programs may comprise instructions to, when executed by the electronic device, cause the electronic device to, based on the angle, the reference angle, and the direction, identify the number in which the data is to be iteratively provided to the trained model. The one or more programs may comprise instructions to, when executed by the electronic device, cause the electronic device to iteratively rotate the object by the reference angle in the direction based on iteratively providing the data to the trained model according to the identified number. The one or more programs may comprise instructions to, when executed by the electronic device, cause the electronic device to, based on iteratively rotating the object by the reference angle in the direction, obtain the object that has the second posture.

For example, the one or more programs may comprise instructions to, when executed by the electronic device, cause the electronic device to, based on the angle, the reference angle, and another direction opposite to the direction, identify another number in which another data associated with the object is to be iteratively provided to the trained model. The one or more programs may comprise instructions to, when executed by the electronic device, cause the electronic device to, based on the number less than the another number, determine the direction as a direction in which the object to be rotated. The one or more programs may comprise instructions to, when executed by the electronic device, cause the electronic device to iteratively rotate the object by the reference angle in the direction based on iteratively providing the data to the trained model according to the number.

For example, the one or more programs may comprise instructions to, when executed by the electronic device, cause the electronic device to, based on identifying the number, generate a prompt indicating the direction and the angle. The one or more programs may comprise instructions to, when executed by the electronic device, cause the electronic device to iteratively rotate the object by the reference angle in the direction based on further providing the prompt to the trained model.

For example, the angle may be a first angle. The reference angle may be a first reference angle. The data may be first data. The number may be a first number. The one or more programs may comprise instructions to, when executed by the electronic device, cause the electronic device to, based on the user input, identify a second angle by which the object is to be rotated about a first axis to change a posture of the object from the first posture to a third posture between the first posture and the second posture. The one or more programs may comprise instructions to, when executed by the electronic device, cause the electronic device to, based on the second angle and a second reference angle, identify a second number in which second data associated with the object is to be iteratively provide to the trained model. The one or more programs may comprise instructions to, when executed by the electronic device, cause the electronic device to iteratively rotate the object by the second reference angle about the first axis based on iteratively providing the second data to the trained model according to the second number. The one or more programs may comprise instructions to, when executed by the electronic device, cause the electronic device to, based on iteratively rotating the object by the second reference angle about the first axis, obtain the object that has the third posture. The one or more programs may comprise instructions to, when executed by the electronic device, cause the electronic device to identify a third angle by which the object is to be rotated about a second axis to change a posture of the object from the third posture to the second posture. The one or more programs may comprise instructions to, when executed by the electronic device, cause the electronic device to, based on the third angle and a third reference angle, identify a third number in which third data associated with the object is to be iteratively provided to the trained model. The one or more programs may comprise instructions to, when executed by the electronic device, cause the electronic device to iteratively rotate the object by the third reference angle about the second axis based on iteratively providing the third data to the trained model according to the third number. The one or more programs may comprise instructions to, when executed by the electronic device, cause the electronic device to, based on iteratively rotating the object by the third reference angle about the second axis, obtain the object that has the second posture.

For example, the trained model may be a first trained model, and may include a second trained model used to rotate the object about the first axis and a third trained model used to rotate the object about the second axis. The one or more programs may comprise instructions to, when executed by the electronic device, cause the electronic device to iteratively rotate the object by the second reference angle about the first axis based on iteratively providing the second data to the second trained model according to the second number. The one or more programs may comprise instructions to, when executed by the electronic device, cause the electronic device to, based on iteratively rotating the object by the second reference angle about the first axis, obtain the object that has the third posture. The one or more programs may comprise instructions to, when executed by the electronic device, cause the electronic device to iteratively rotate the object by third reference angle about the second axis, based on iteratively providing the third data to the third trained model according to the third number. The one or more programs may comprise instructions to, when executed by the electronic device, cause the electronic device to, based on iteratively rotating the object by the third reference angle about the second axis, obtain the object that has the second posture.

For example, at least one among the first trained model, the second trained model, and the third trained model may include a low-rank adaptation (LoRA) model.

For example, the one or more programs may comprise instructions to, when executed by the electronic device, cause the electronic device to obtain the second image by synthesizing the object that has the second posture and the first image.

For example, the one or more programs may comprise instructions to, when executed by the electronic device, cause the electronic device to, based on the angle and the reference angle, determine whether to flip the object before rotating the object. The one or more programs may comprise instructions to, when executed by the electronic device, cause the electronic device to, based on determining not to flip the object, identify the number in which the data is to be iteratively provided to the trained model according to the angle and the reference angle. The one or more programs may comprise instructions to, when executed by the electronic device, cause the electronic device to identify another angle by which the object is to be rotated to change a posture of the object from the third posture to the second posture. The one or more programs may comprise instructions to, when executed by the electronic device, cause the electronic device to, based on the another angle and the reference angle, identify another number in which another data associated with the object is to be iteratively provided to the trained model. The one or more programs may comprise instructions to, when executed by the electronic device, cause the electronic device to iteratively rotate the object by the reference angle based on iteratively providing the another data to the trained model according to the another number. The one or more programs may comprise instructions to, when executed by the electronic device, cause the electronic device to, based on iteratively rotating the object by the reference angle, obtain the object that has the second posture. The one or more programs may comprise instructions to, when executed by the electronic device, cause the electronic device to obtain the second image including the object that has the second posture.

For example, the one or more programs may comprise instructions to, when executed by the electronic device, cause the electronic device to compare the identified number with the identified another number. The one or more programs may comprise instructions to, when executed by the electronic device, cause the electronic device to, based on the another number more than the number, determine not to flip the object. The one or more programs may comprise instructions to, when executed by the electronic device, cause the electronic device to, based on the another number less than the number, determine to flip the object.

For example, the one or more programs may comprise instructions to, when executed by the electronic device, cause the electronic device to obtain a noise image by providing the data to the trained model. The one or more programs may comprise instructions to, when executed by the electronic device, cause the electronic device to, based on providing the noise image to the trained model again, rotate the object by the reference angle.

For example, the user input may further indicate selecting the object as an object to be rotated.

For example, the data may include the object that has the first posture and the object rotated by the reference angle N times while changing a posture of the object from the first posture to the second posture. The N may be a natural number.

While the disclosure been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory, comprising one or more storage mediums, storing instructions;
a display; and
at least one processor comprising processing circuitry,
wherein the instructions, when individually or collectively executed by the at least one processor, cause the electronic device to:
display, via the display, a first image including an object that has a first posture;
receive a user input to change the first posture of the object to a second posture of the object;
based on the user input, identify an angle by which the object is to be rotated to change a posture of the object from the first posture to the second posture;
based on the angle and a reference angle, identify a number in which data associated with the object is to be iteratively provided to a trained model;
iteratively rotate the object by the reference angle based on iteratively providing the data to the trained model according to the identified number;
based on iteratively rotating the object by the reference angle, obtain the object that has the second posture; and
obtain a second image including the object that has the second posture.

2. The electronic device of claim 1, wherein the instructions, when individually or collectively executed by the at least one processor, cause the electronic device to:
based on the user input, identify a direction in which the object is to be rotated to change a posture of the object from the first posture to the second posture;
based on the angle, the reference angle, and the direction, identify the number in which the data is to be iteratively provided to the trained model;
iteratively rotate the object by the reference angle in the direction based on iteratively providing the data to the trained model according to the identified number; and
based on iteratively rotating the object by the reference angle in the direction, obtain the object that has the second posture.

3. The electronic device of claim 2, wherein the instructions, when individually or collectively executed by the at least one processor, cause the electronic device to:
based on the angle, the reference angle, and another direction opposite to the direction, identify another number in which another data associated with the object is to be iteratively provided to the trained model;
based on the number less than the another number, determine the direction as a direction in which the object to be rotated; and
iteratively rotate the object by the reference angle in the direction based on iteratively providing the data to the trained model according to the number.

4. The electronic device of claim 2, wherein the instructions, when individually or collectively executed by the at least one processor, cause the electronic device to:
based on identifying the number, generate a prompt indicating the direction and the angle, and
iteratively rotate the object by the reference angle in the direction based on further providing the prompt to the trained model.

5. The electronic device of claim 1,
wherein the angle is, a first angle,
wherein the reference angle is, a first reference angle,
wherein the data is, first data, and
wherein the number is, a first number,
wherein the instructions, when individually or collectively executed by the at least one processor, cause the electronic device to:
based on the user input, identify a second angle by which the object is to be rotated about a first axis to change a posture of the object from the first posture to a third posture between the first posture and the second posture;
based on the second angle and a second reference angle, identify a second number in which second data associated with the object is to be iteratively provided to the trained model;
iteratively rotate the object by the second reference angle about the first axis based on iteratively providing the second data to the trained model according to the second number;
based on iteratively rotating the object by the second reference angle about the first axis, obtain the object that has the third posture;
identify a third angle by which the object is to be rotated about a second axis to change a posture of the object from the third posture to the second posture;
based on the third angle and a third reference angle, identify a third number in which third data associated with the object is to be iteratively provided to the trained model;
iteratively rotate the object by the third reference angle about the second axis based on iteratively providing the third data to the trained model according to the third number; and
based on iteratively rotating the object by the third reference angle about the second axis, obtain the object that has the second posture.

6. The electronic device of claim 5,
wherein the trained model is a first trained model,
wherein the trained model includes a second trained model used to rotate the object about the first axis and a third trained model used to rotate the object about the second axis, and
wherein the instructions, when individually or collectively executed by the at least one processor, cause the electronic device to:
iteratively rotate the object by the second reference angle about the first axis based on iteratively providing the second data to the second trained model according to the second number;
based on iteratively rotating the object by the second reference angle about the first axis, obtain the object that has the third posture;
iteratively rotate the object by third reference angle about the second axis based on iteratively providing the third data to the third trained model according to the third number; and
based on iteratively rotating the object by the third reference angle about the second axis, obtain the object that has the second posture.

7. The electronic device of claim 6,
wherein at least one among the first trained model, the second trained model, or the third trained model, includes a low-rank adaptation (LoRA) model.

8. The electronic device of claim 1, wherein the instructions, when individually or collectively executed by the at least one processor, cause the electronic device to:
obtain the second image by synthesizing the object that has the second posture and the first image.

9. The electronic device of claim 1, wherein the instructions, when individually or collectively executed by the at least one processor, cause the electronic device to:
based on the angle and the reference angle, determine whether to flip the object before rotating the object;
based on determining not to flip the object, identify the number in which the data is to be iteratively provided to the trained model according to the angle and the reference angle;
based on determining to flip the object, obtain the object that has a third posture by flipping the object;
identify another angle by which the object is to be rotated to change a posture of the object from the third posture to the second posture;
based on the another angle and the reference angle, identify another number in which another data associated with the object is to be iteratively provided to the trained model;
iteratively rotate the object by the reference angle based on iteratively providing the another data to the trained model according to the another number;
based on iteratively rotating the object by the reference angle, obtain the object that has the second posture; and
obtain the second image including the object that has the second posture.

10. The electronic device of claim 9, wherein the instructions, when individually or collectively executed by the at least one processor, cause the electronic device to:
compare the identified number with the identified another number;
based on the another number more than the number, determine not to flip the object; and
based on the another number less than the number, determine to flip the object.

11. The electronic device of claim 1, wherein the instructions, when individually or collectively executed by the at least one processor, cause the electronic device to:
obtain a noise image by providing the data to the trained model, and
based on providing the noise image to the trained model again, rotate the object by the reference angle.

12. The electronic device of claim 1, wherein the user input further indicates selecting the object as an object to be rotated.

13. The electronic device of claim 1,
wherein the data includes the object that has the first posture and the object rotated by the reference angle N times while changing a posture of the object from the first posture to the second posture, and
wherein the N is a natural number.

14. A method executed in an electronic device comprising a display the method comprising:
displaying, via the display, a first image including an object that has a first posture;
receiving a user input to change the first posture of the object to a second posture of the object;
based on the user input, identifying an angle by which the object is to be rotated to change a posture of the object from the first posture to the second posture;
based on the angle and a reference angle, identifying a number in which data associated with the object is to be iteratively provided to a trained model;
iteratively rotating the object by the reference angle based on iteratively providing the data to the trained model according to the identified number;
based on iteratively rotating the object by the reference angle, obtaining the object that has the second posture; and
obtaining a second image including the object that has the second posture.

15. The method of claim 14, the method further comprising:
based on the user input, identifying a direction in which the object is to be rotated to change a posture of the object from the first posture to the second posture;
based on the angle, the reference angle, and the direction, identifying the number in which the data is to be iteratively provided to the trained model;
iteratively rotating the object by the reference angle in the direction based on iteratively providing the data to the trained model according to the identified number; and
based on iteratively rotating the object by the reference angle in the direction, obtaining the object that has the second posture.

16. The method of claim 15, the method further comprising:
based on the angle, the reference angle, and another direction opposite to the direction, identifying another number in which another data associated with the object is to be iteratively provided to the trained model;
based on the number less than the another number, determining the direction as direction in which the object to be rotated; and
iteratively rotating the object by the reference angle in the direction based on iteratively providing the data to the trained model according to the number.

17. The method of claim 15, the method further comprising:
based on identifying the number, generating a prompt indicating the direction and the angle; and
iteratively rotating the object by the reference angle in the direction based on further providing the prompt to the trained model.

18. The method of claim 14, wherein the angle by which the object is to be rotated to change from the first posture to the second posture is configured with an angle about a first axis of the object that has the first posture and an angle about a second axis of the object that has the first posture.

19. The method of claim 14, wherein the identified number in which the data associated with the object is to be iteratively provided is determined as N times the reference angle corresponding to the angle by which the object is to be rotated.

20. A non-transitory computer readable storage medium storing one or more programs, the one or more programs comprising instructions to, when executed by an electronic device with a display, cause the electronic device to:
display, via the display, a first image including an object that has a first posture;
receive a user input to change the first posture of the object to a second posture of the object;
based on the user input, identify an angle by which the object is to be rotated to change a posture of the object from the first posture to the second posture;
based on the angle and a reference angle, identify a number in which data associated with the object is to be iteratively provided to a trained model;
iteratively rotate the object by the reference angle based on iteratively providing the data to the trained model according to the identified number;
based on iteratively rotating the object by the reference angle, obtain the object that has the second posture; and
obtain a second image including the object that has the second posture.
